(19) United States
(12) Patent Application Publication
(10) Pub. No.: US 2005/0032511 A1
(43) Pub. Date: Feb. 10, 2005

(54) Wireless firmware download to an external device

(75) Inventors: Jason Allen Malone, Lino Lakes, MN (US); Jay William Axelrod, Minneapolis, MN (US); William Robert Mass, Maple Grove, MN (US); Richard Earl Stein, Edina, MN (US); Robert Joseph Gaskill, Edina, MN (US)

Correspondence Address: MERCHANT & GOULD PC, P.O. BOX 2903, MINNEAPOLIS, MN, 55402-0903, US

(73) Assignee: Cardiac Pacemakers, Inc.

(21) Appl. No.: 10/636,819

(22) Filed: Aug. 7, 2003

(51) Int. Cl. G06F 9/24; H04M 3/00

(52) U.S. Cl. 455/420; 713/1; 455/418

(57) ABSTRACT

The present invention relates to a method and apparatus for programming a wireless handheld device and communicating between the handheld device and a programmer using inductive telemetry. The method may include the steps of activating a boot load mode of the handheld device, positioning the handheld device in proximity to a programming device, and downloading firmware to the handheld device from the programming device using inductive telemetry. The apparatus may include an inductive coil for inductive telemetry and a memory. The inductive coil is configured to be activated in response to inductive signals from an inductive coil of the programmer, thereby providing communication between the handheld device and the programmer. Communication between the handheld device and the programmer may include downloading firmware to the handheld device, and storing the downloaded firmware in the memory.

### BACKGROUND OF THE INVENTION

1. Field of the Invention

The invention generally relates to communication devices, and more specifically relates to wireless handheld devices that communicate using inductive telemetry.

2. Related Art

Implantable medical devices are becoming increasingly versatile and able to perform many different physiological sensing functions that enable a clinician to quickly and accurately assess patient health. Traditionally, an accurate assessment of patient health required the clinician to synthesize often divergent or seemingly unrelated indications of patient health. For example, a diagnosis of congestive heart failure might include not only an assessment and evaluation of cardiac function data, but also an evaluation of other physiological factors like patient fatigue or respiration data.

Typically, a clinician will assess patient health by inquiring how the patient feels or asking about the patient's activities and then make an indirect assessment based on the patient's response and the clinician's observation of the patient's appearance. However, these measures are very subjective and are limited to the time of the patient/clinician interaction and the quality of patient recall or willingness to divulge information. These factors affect the quality of the assessment.

Modern implantable medical devices offer objective data to help the clinician assess patient health. Modern medical devices can sense and analyze physiological factors with improved accuracy and report that sensed and analyzed information to the clinician or the patient. The data or information that a medical device reports in the form of a sensed physiological parameter can be characterized as either derived or non-derived data. Non-derived data can be understood as raw biometric information sensed by the medical device that has not been clinically analyzed to any meaningful degree. For example, non-derived biometric information may comprise the quantified measurement of a patient's heart rate or blood pressure. In contrast, derived data is biometric information that has been analyzed and perhaps assigned some qualitative value. For example, as a medical device senses a patient's cardiac cycle and clinically analyzes that information, the medical device may report that an arrhythmia has occurred as the result of sensing and analyzing a cardiac rhythm outside expected parameters. Other derived sensors may include the cumulative calories burned by daily activity, a weight loss monitor, a participation in activities monitor, a depression monitor, or determining the onset of cancer, all of which may be ascertained by sensing physiological data and analyzing that data by using clinically derived algorithms or other analytical methods.

Some implanted medical devices may be part of an advanced Patient Management System that includes various physiological sensors and other features to sense and report patient data. Such a system may be adapted to analyze the sensed data in a manner that yields an accurate assessment or prediction of patient health or relative well-being. In this way, the system can be configured to report not only a relative state of patient health, but also alert the clinician to patient health degradation before the onset of an acute episode.

Accurate and reliable reporting and collection of the most relevant data produced by the above-mentioned medical devices and systems has proven to be difficult and cumbersome in many instances. One drawback of many implanted medical devices is their finite memory available for storage of collected data. Some devices include a rolling memory that stores a limited amount of data, which, if not downloaded from the device in a predetermined time period, is dropped from the memory as it is replaced with newer, incoming data.

Typically, a doctor or clinician must perform data retrieval from a medical device or system during a formal visit and evaluation of the patient. Because of the infrequency of these types of patient visits, much of the data collected by the medical device or system is lost before being retrieved and analyzed by the doctor. Of particular concern is the loss of data related to an important physiological event such as heart failure, asthma attacks, etc., whether or not the occurrence of these events are known to the patient.

A data retrieval mechanism that effectively captures relevant physiological data from an implanted medical device or system would be an important advance in the art.

### SUMMARY OF THE INVENTION

One aspect of the present invention relates to a wireless handheld device configured to communicate with both a programmer and an implanted device. The device may include an inductive coil for inductive telemetry communication and a memory. The inductive coil is configured to be activated in response to inductive signals from an inductive coil of the programmer or implanted device, thereby providing communication between the handheld device and the programmer or implanted device. Communication between the handheld device and the programmer may include downloading firmware to the handheld device using inductive telemetry, and storing the downloaded firmware in the memory.

Another aspect of the present invention relates to a method of programming a wireless handheld device. The method may include the steps of activating a boot load mode of the handheld device, positioning the handheld device in proximity to a programming device, and downloading firmware to the handheld device from the programming device using inductive telemetry.

A yet further aspect of the invention relates to a method of communicating between a wireless handheld device and either or both of an implanted device and a controller. The method may include the steps of placing the handheld device in proximity to the implanted device, communicating between the handheld device and the implanted device using inductive telemetry, placing the handheld device in proximity to the controller, and communicating between the handheld device and the controller using inductive telemetry. Communications between the handheld device and the controller may include downloading of firmware from the controller and storing the firmware in a memory of the handheld device.

### BRIEF DESCRIPTION OF THE DRAWINGS

FIG. 1 is a front perspective view of one embodiment of a personal handheld data retrieval device that incorporates principles of the present invention.

FIG. 2 is a rear perspective view of the device shown in FIG. 1.

FIG. 3 is an exploded perspective view of the device shown in FIG. 1.

FIG. 4 is a schematic representation of the device of FIG. 1 communicating with a controller and an implanted device according to principles of the present invention.

FIG. 5 is a flow diagram illustrating steps in a method according to principles of the present invention.

### DETAILED DESCRIPTION OF THE PREFERRED EMBODIMENT

The present invention relates to a wireless handheld device that is configured to download firmware from a controller and communicate with an implanted device using inductive telemetry. The handheld device may include a boot load mode that is activated so that firmware for the device can be downloaded directly to the handheld device memory. The memory where the firmware is stored is preferably accessible only when the handheld device is in boot load mode. Once the firmware is downloaded, the boot load mode is de-activated and the new firmware controls operation of the handheld device. The handheld device preferably includes an inductive coil that is configured to communicate with an inductive coil of the controller to facilitate downloading of the firmware. In some embodiments, the inductive coil may also be used to communicate with an inductive coil of an implanted device to send information to the implanted device, such as software and control information, and receive information from the implanted device, such as physiological data and self-test results.

A personal handheld device that uses inductive telemetry for communicating with a controller and an implanted device may be advantageous for several reasons. Many known implantable medical devices use inductive telemetry as a communication medium. Inductive telemetry is a safe, simple and effective medium for communication between devices, whether the devices are implanted or not. Typically, an implanted device with inductive telemetry capabilities communicates with a programmer via some sort of “wand” or other mobile device that is hard wired to the programmer for purposes of powering the wand and communication of information back and forth between the controller and the implanted device. Because of the cost and immobility of the controller, a patient with an implanted device typically has to visit a doctor or be visited by a clinician of some type in order for the inductive telemetry communication to take place. Furthermore, known “wands” or the like inductive telemetry devices for communicating with the implanted device have high power requirements and are not well suited for mobile use by a patient. Using the same technology (inductive telemetry) in the handheld device to communicate with both the implanted device and the controller may simplify the electronics and controls of the handheld device.

The present invention addresses these and other disadvantages of known devices and systems for retrieving data from an implanted device and communicating with a controller, some of which are described in the above background section. The present invention is configured for use by a patient and is capable of operation using battery power. The present invention is compact, mobile, relatively easy to use, and includes circuitry and control electronics that are simple and compatible with many known controllers and implantable devices.

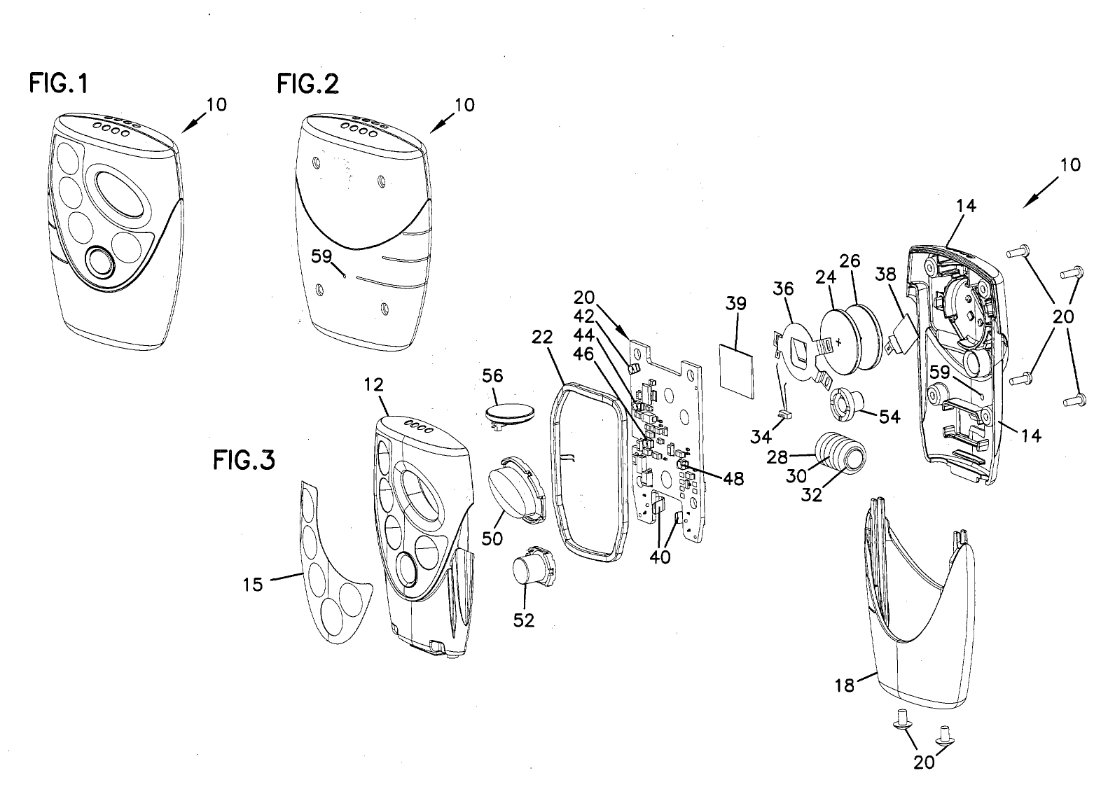

One example of a handheld device of the present invention is device 10 shown in FIGS. 1-3. Device 10 includes a front cover 12 with an overlay 15, rear cover 14, first fasteners 16 that secure the front and rear covers 12, 14 together, a bottom cover 18, and second fasteners 20 that secure bottom cover 18 to the combined front and rear covers 12, 14. Device 10 also includes an inductive coil 22, telemetry batteries 24, 26, and system batteries 28, 30, 32. A plug harness 34, a battery clip 36, and a bottom contact 38 are associated with telemetry batteries 24, 26.

Device 10 may also include a printed circuit board (PCB) assembly 20 to which many of the electronic components of device 10, including memory (not specifically designated, but generally known to be positioned on PCB assembly 20) are mounted. PCB assembly 20 may include system battery leads 40 for the system batteries 28, 30, 32, and LEDs 42, 44, 46, 48 that can be seen through front cover 12 when illuminated.

Activating buttons of device 10 may be used to control various functions of the device. Device 10 may include an inquiry button 50, a therapy button 52, and a volume button 54. Device 10 preferably also includes some type of reset button (not shown) that is positioned within device 10 at a location so as not to be inadvertently activated. The reset button may be mounted to PCB 20 and accessible through, for example, a small aperture 59 in rear cover 14 (see FIGS. 2 and 3). When engaged, the reset button (possibly in combination with activation of other buttons of the device) may activate a boot load or similar reset mode of device 10. Device 10 may also include an indicator, such as one of LEDs 42, 44, 46, 48 that illuminates or speaker 56 that provides an audible signal, when the boot load mode is activated.

Device 10 may also include a speaker 56 that provides audible messages from the device, and an insulator 58 positioned between telemetry batteries 24, 26 and components mounted to PCB 20. Device 10 may also be configured to be compatible with alternative features and structure that are not shown in FIGS. 1-3, but that may be advantageous for purposes related to inductive telemetry communications.

Device 10 includes firmware that is used to control various functions of the device. The firmware functions essentially as the logic of the hardware (e.g., bios) and is often considered a permanent part of the hardware. Typically, the firmware is stored in a separate and distinct memory location that is protected from accidental erasure or corruption. Firmware is different from software (such as an operating system (“OS”)), which is typically easily changeable and removable from memory of the device. Firmware is also different from hardware, which is tangible and has structure as opposed to the intangible nature of firmware.

The firmware of a device may need to be changed for several reasons. For example, if upgraded firmware has been developed or a “bug” removed from a particular version of firmware for a particular device, the old firmware must be removed or otherwise replaced with the new firmware. Known methods of adding original or updated firmware to a device include radio frequency (RF), firewire, and universal serial bus (USB) communications. These known methods of communicating firmware and other types of information between devices have certain drawbacks that are addressed by using inductive telemetry. RF communications typically require encryption of the information being transferred. Firewire and USB communications require wires to connect the devices together. When downloading firmware or other information to a device that is capable of wireless communication with other devices (such as, for example, an implanted device), the device would require both hard wire and wireless communication capabilities if using firewire or USB connections for firmware downloading.

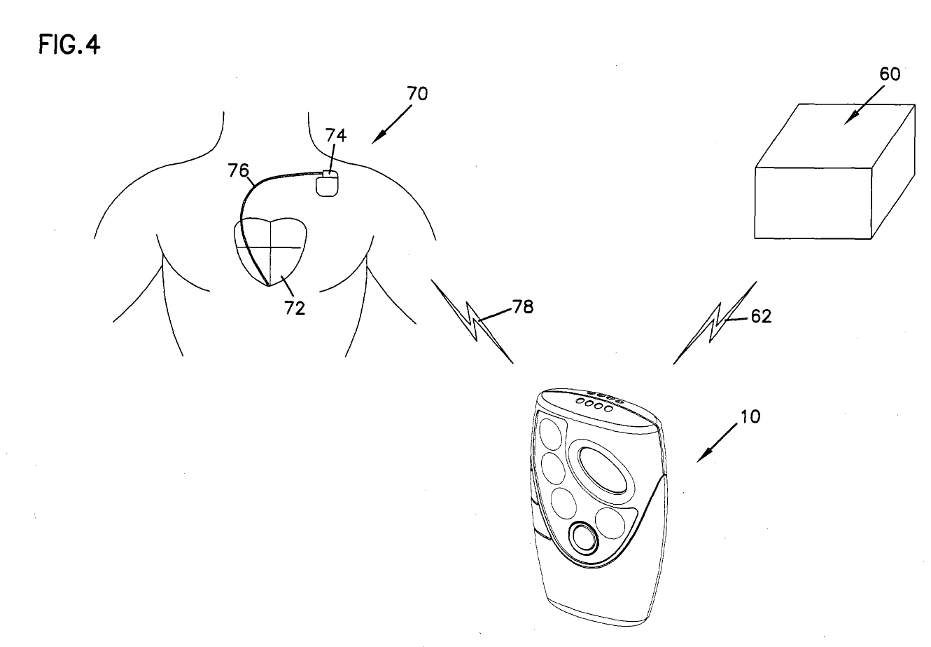

Referring now to FIG. 4, device 10 is shown in wireless communication 62 with a programmer 60 and in wireless communication 78 with an implanted device 74. Device 10 is preferably configured for wireless communication with implanted device 74 to collect information about heart 72 that is gathered using electrode 76 and stored in implanted device 74. Wireless communications between device 10 and implanted device 74 may also include, for example, transfer of updated control and testing information and parameters for the implanted device, parameters for the implanted device related to collection of patient data, therapy information for limited treatment of the patient (such as heart 72 of the patient) provided by the implanted device, self-test information from the implanted device, and patient data collected by the implanted device. Communication 78 is preferably performed using inductive telemetry.

Device 10 is also preferably configured for wireless communication with programmer 60 to transfer information from device 10 that has been collected from implanted device 74. Wireless communication between device 10 and programmer 60 may also include transfer of control information (such as the firmware discussed above), software, software patches, patient information, test sequences, etc. from the programmer for use in implanted device 74 or device 10. Communication 62 is also preferably performed using inductive telemetry.

Inductive telemetry technology requires separate inductive coils (for example an inductive coil in separate devices) for effective communication. Activating one inductive coil with a given signal cause activation of the second inductive coil, thereby transferring the signal to the second inductive coil. Transfer of a signal between inductive coils is dependent on distance and the strength of the initial signal. When using wireless devices for inductive telemetry, such as device 10 that runs on battery power, the inductive signal produced by the wireless device is typically relatively weak so as to conserve energy. Thus, the inductive coils in this instance must be positioned close by each other in order for the inductive telemetry communication to occur.

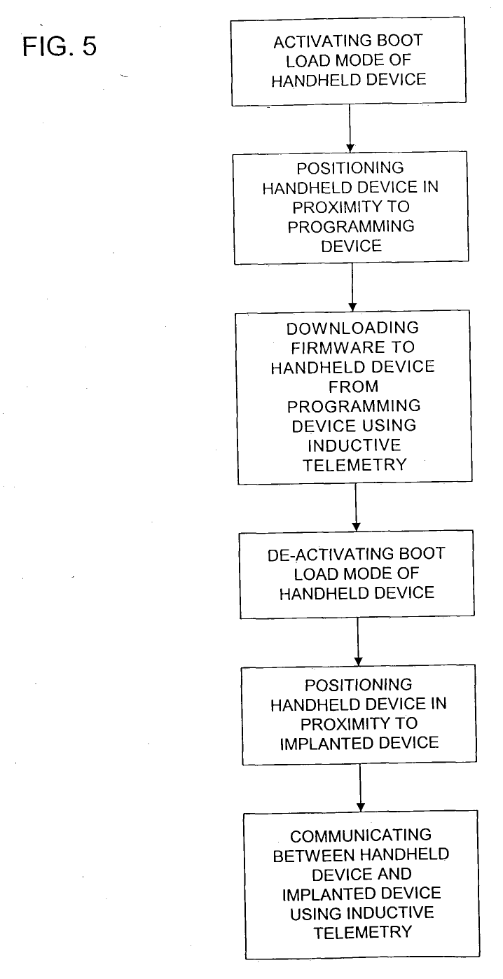

A method of using device 10 according to principles of the present invention may include steps as illustrated in FIG. 5. The method may include activating a boot load mode of the handheld device, for example, using a reset or combination of other buttons of the handheld device. Typically, when using inductive telemetry communications, the handheld device must be positioned in relative close proximity to a programming device to download firmware to the handheld device from the programming device. After the new firmware is downloaded from the programming device, the boot load mode of the handheld device is de-activated so that the firmware is operational in the handheld device. With the new firmware operational in the handheld device, the handheld device may be used to communicate with an implanted device by positioning the handheld device in relative close proximity to the implanted device and communicating between the handheld device and the implanted device using inductive telemetry.

FIG. 5 includes steps directed to communications between both a programmer and an implanted device, but may, in other embodiments, be directed more specifically to communications between only a programmer and a handheld device. For example, the step of communicating information between the handheld device and the implanted device may include communicating test parameters for testing of the implanted device, communicating parameters for collection of patient data by the implanted device, communicating therapy information for limited treatment of the patient provided by the implanted device, and communicating test results from testing of the implanted device

Other steps of a method according to principles of the present invention may include storing the downloaded firmware in a memory of the handheld device. The memory of the handheld device may include a protected portion or a secondary memory for storing the firmware that is only accessible when the handheld device is in a boot load or similar mode. Another method step may include communicating information other than firmware between the handheld device and the programmer.

The above specification, examples and data provide a complete description of the manufacture and use of the composition of the invention. Since many embodiments of the invention can be made without departing from the spirit and scope of the invention, the invention resides in the claims hereinafter appended.

1. A method of programming a wireless handheld device, comprising:
activating a boot load mode of the handheld device;
positioning the handheld device in proximity to a programming device;
downloading firmware to the handheld device from the programming device using inductive telemetry.

2. The method of claim 1, wherein the wireless handheld device include a first memory, the first memory being accessible only during activation of the boot load mode, the method further comprising the step of storing the downloaded firmware in the first memory.

3. The method of claim 2, wherein the downloaded firmware overwrites any firmware previously stored in the first memory.

4. The method of claim 1, further comprising the step of communicating data other than firmware for the handheld device between the programming device and the handheld device.

5. The method of claim 4, wherein the handheld device includes a second memory, the method further comprising the step of storing communicated date other than firmware for the handheld device in the second memory.

6. A wireless handheld device configured to communicate with a programmer, comprising:
an inductive coil for inductive telemetry, the inductive coil configured to be activated in response to inductive signals from an inductive coil of the programmer; and
a memory;
whereby communication between the handheld device and the programmer includes downloading firmware to the handheld device using inductive telemetry and storing the downloaded firmware in the memory.

7. The handheld device of claim 6, further comprising a boot load mode configured for activation prior to downloading the firmware to the handheld device.

8. The handheld device of claim 7, further comprising a boot load mode reset button and an indicator, the indicator providing a signal in response to activation of the boot load mode with the boot load mode reset button.

9. A method of communicating between a wireless handheld device and an implanted device and a controller, comprising the steps of:
placing the handheld device in proximity to the implanted device;
communicating between the handheld device and the implanted device using inductive telemetry;
placing the handheld device in proximity to the controller; and
communicating between the handheld device and the controller using inductive telemetry.

10. The method of claim 9, wherein communicating between the handheld device and the controller includes downloading firmware from the controller to the handheld device.

11. The method of claim 10, further including the step of activating a boot load mode of the handheld device prior to the step of downloading firmware to the handheld device.

12. The method of claim 11, wherein the handheld device includes a first memory, the first memory being assessable only when the handheld device is in the boot load mode, the method further comprising the step of saving the downloaded firmware to a first memory.

13. The method of claim 12, wherein the handheld device includes a second memory, and the step of communicating between the handheld device and the implanted device includes communicating data, the method further comprising the step of saving the communicated data in the second memory.

14. The method of claim 12, wherein the handheld device includes a second memory, and the step of communicating between the handheld device and the controller further comprises communicating data other than firmware from the controller to the handheld device, the method further comprising the step of saving communicated data other than firmware in the second memory.

15. The method of claim 9, wherein the step of communicating between the handheld device and the implanted device includes communicating data from the handheld device to the implanted device.

16. The method of claim 15, wherein the communicated data is test parameters for testing of the implanted device.

17. The method of claim 15, wherein the communicated data is software for the implanted device.

18. The method of claim 15, wherein the communicated data is parameters for collection of patient data by the implanted device.

19. The method of claim 9, wherein the step of communicating between the handheld device and the implanted device includes communicating data from the implanted device to the handheld device.

20. The method of claim 19, wherein the communicated data is physiological data collected by the implanted device.

21. The method of claim 19, wherein the communicated data is test results from testing the implanted device.
